(19) United States
(12) Patent Application Publication
(10) Pub. No.: US 2007/0087266 A1
(43) Pub. Date: Apr. 19, 2007

(54) Modular battery system

(76) Inventors: Debbi Bourke, Rochester, MI (US); Hans Ian Johnson, Washington Township, MI (US); Jonathan Locher Freiman, Royal Oak, MI (US); Robert John Melichar, Troy, MI (US); Nick Karditsas, Lake Orion, MI (US)

Correspondence Address: COBASYS, LLC, 3740 LAPEER ROAD SOUTH, ORION, MI, 48359, US

(21) Appl. No.: 11/252,925

(22) Filed: Oct. 18, 2005

(51) Int. Cl. H01M 10/04; H01M 10/50

(52) U.S. Cl. 429/159; 429/120; 429/61

(57) ABSTRACT

Disclosed herein is a modular battery system having at least one set of battery modules, preferably monoblock modules connected in series. Each of the battery modules may be designed with a first endplate and a second endplate, wherein each battery module is set between the first and second endplates and at least one band member couples the endplates to each other, binding the battery module between the endplates. The endplates are secured between a pair of rails and the system is disposed in a system housing. A cooling manifold provides a system wherein coolant flows into and out of each battery module. The system housing preferably has a coolant inlet and a coolant outlet. The cooling manifold is in flow communication with the coolant inlet and the coolant outlet. A battery monitoring system, which may include a battery control module and at least one remote sensing module, preferably monitors and collects performance and status information, such as voltage and temperature, of the battery modules. An integrated control unit (ICU) may be disposed in the system housing. The ICU supports electronics, some of which are used to collect electrical energy produced by the battery modules and/or monitor the system.

### FIELD OF THE INVENTION

The instant invention relates generally to improvements in rechargeable high performance batteries, modules and packs. Specifically, the invention relates to multi-cell, monoblock batteries incorporated into a modular battery system.

### BACKGROUND OF THE INVENTION

Rechargeable nickel-metal hydride (Ni-MH) batteries are used in a variety of industrial and commercial applications such as fork lifts, golf carts, uninterruptible power supplies, pure electric vehicles and hybrid electric vehicles. Vehicular applications include applications related to propulsion as well as applications related to starting, lighting and ignition.

One aspect of battery operation that is particularly important for electric vehicle and hybrid vehicle applications is that of thermal management. In both electric and hybrid vehicle applications individual electrochemical cells are bundled together in close proximity. Many cells are both electrically and thermally coupled together. Therefore, the nickel-metal hydride batteries used in these applications may generate significant heat during operation. Sources of heat are primarily threefold. First, ambient heat due to the operation of the vehicle in hot climates. Second, resistive or I²R heating on charge and discharge, where I represents the current flowing into or out of the battery and R is the resistance of the battery. Third, a tremendous amount of heat is generated during overcharge due to gas recombination.

A battery generates Joule's heat and reaction heat due to electrode reaction at charging and discharging operations. A module battery including a series of cells having such a large capacity or a pack battery including a series of the module batteries is configured of several tens to several hundreds of the cells arranged contiguously to each other. The cells, with an increased electric capacity and sealed configuration, increase in the amount of heat accumulation, with the result that heat dissipation out of the battery is retarded and the generated heat is accumulated within the battery. Consequently, the internal temperature of such a battery rises by a degree more than that of a smaller battery. U.S. Pat. No. 5,879,831 hereinafter “831 Patent”) discloses battery module having a plurality of individual batteries secured by bundling/compression means welded at the corners to restrict the batteries from moving or dislodging when subjected to mechanical vibrations of transport or use. U.S. Pat. No. 5,663,008 (hereinafter “008 Patent”) discloses a module battery having a plurality of cells secured between two ends plates and band-like binding members for coupling the endplates. The primary purpose of the design disclosed is to prevent deformation of the battery casing. However, neither the '831 patent nor the '008 patent describes a modular battery system with multiple modules secured with rails. Also, neither the '831 patent nor the '008 patent discloses a module having internal electrical connections between the individual cells within a monoblock.

While issues regarding heat dissipation are generally common to all electrical battery systems, they are particularly important to nickel-metal hydride battery systems. This is because Ni-MH has a high specific energy and the charge and discharge currents are also high. Second, because Ni-MH has an exceptional energy density (i.e. the energy is stored very compactly) heat dissipation is more difficult than, for example, lead-acid batteries. This is because the surface-area to volume ratio is much smaller than lead-acid, which means that while the heat being generated is much greater for Ni-MH batteries than for lead acid, the heat dissipation surface is reduced.

In addition, while the heat generated during charging and discharging Ni-MH batteries is normally not a problem in small consumer batteries however, larger batteries (particularly when more than one is used in series or in parallel) generate sufficient heat on charging and discharging to affect the ultimate performance of the battery.

Thermal management issues for nickel-metal hydride batteries are addressed in U.S. Pat. No. 6,255,015, U.S. Pat. No. 6,864,013 and U.S. patent application Ser. No. 10/848,277 are all of which are hereby incorporated herein by reference.

An example of a monoblock battery is provided in U.S. Pat. No. 5,356,735 to Meadows et al, which is incorporated by reference herein. Another example is provided in U.S. Pat. No. 6,255,015 to Corrigan et al, which is hereby incorporated by reference herein.

Currently there exists a need in the art for a modular battery system that provides stability for individual modules and thermal management of the system to reduce, among other things, overheating of the system, deformation of the casings and shock to the system. Further, there exists a need in the art for a modular battery system that utilizes a battery management system to monitor the performance and status information of each battery module in the modular battery system.

### SUMMARY OF THE INVENTION

Disclosed herein is a modular battery system having at least one set of battery modules, preferably monoblock modules, connected in series. Each of the battery modules may be designed with a first endplate and a second endplate, wherein each battery module is set between the first and second endplates and at least one band member couples the endplates to each other, binding the battery module between the endplates. The endplates are secured between a pair of rails and the system is disposed in a system housing. A cooling manifold provides a system wherein coolant flows into and out of each battery module; preferably the manifold comprises an interlocking system of flow channels. The system housing preferably has a coolant inlet and a coolant outlet. The cooling manifold is in flow communication with the coolant inlet and the coolant outlet. Additionally, embodiments include various securing and stabilizing mechanisms, such as support beams, flanges and hold down bars, which allow the modular battery system of the present invention to withstand a variety of applications that cause mechanical vibrations. Preferably, the modular battery system of the present invention allows for lift by means of a forklift along an axis and is a self-contained assembly that supports and mounts system components.

Preferably, the system includes a mechanism for releasing gases from the system while preventing the exit or entry of moisture, such as a gas-permeable, hydrophobic membrane set into openings in a system cover or the system housing. Preferably, the modular battery system of the present invention includes a battery monitoring system (BMS) that monitors battery voltages, battery temperatures battery pack voltage, battery pack current and dielectric isolation.

Disclosed herein is a modular battery system having an integrated control unit (ICU) that may be disposed in a system housing. The ICU supports electronics, some of which are used to collect electrical energy produced by the battery modules and monitor the system. Preferably, the ICU includes a battery control module BCM), a fuse, a shunt, a main positive contactor, a main negative contactor, a pre-charge relay and pre-charge resistors. Preferably, each module is in electrical communication with a remote sensing module (RSM), wherein each RSM may communicate with more than one module. The RSM collects performance and status information of each battery module, such as voltage and temperature and relays the information to the BCM. Preferably, the addresses of the RSMs allow the BCM to retrieve the data from all of the RSMs independently.

In another embodiment, disclosed herein is a modular battery system having at least one subsystem comprising a plurality of battery modules, preferably connected in series. The subsystem comprises the battery modules, each having a first endplate and a second endplate, wherein the each module is set between respective first and second endplates. A plurality of band member couples each of first and second endplates to each other and binds the battery module between the endplates. Further, the endplates are secured between a pair of rails, preferably by bolting an endplate to a proximately located rail. A cooling manifold provides a system wherein coolant flows into and out of each battery module; preferably the manifold comprises an interlocking system of flow channels. Preferably, the modular battery system comprises at least a first subsystem. However, any number of subsystems nay be incorporated with coolant jumpers connecting the respective cooling manifolds of the subsystems to allow coolant to flow in series from the first subsystem to the last subsystem. Each subsystem may be disposed in a system housing, wherein the system housing has a coolant inlet and a coolant outlet. The coolant inlet may be in flow communication with the first subsystem cooling manifold and the coolant outlet may be in flow communication with the last subsystem cooling manifold.

### BRIEF DESCRIPTION OF THE DRAWINGS

In order to assist in the understanding of the various aspects of the present invention and various embodiments thereof, reference is now made to the appended drawings, in which like reference numerals refer to like elements. The drawings are exemplary only, and should not be construed as limiting the invention.

FIG. 1A is a perspective view of an embodiment of a modular battery system wherein monoblock modules are connected in series in a 12×2 array, wherein a hold down bars aid in securing components of the system;

FIG. 1B is a perspective view of an embodiment of a modular battery system having a cover;

FIG. 1C is a perspective view of an embodiment of a modular battery system wherein monoblock modules are connected in series in a 12×2 array, wherein a hold channel clamps aid in securing components of the system, including flow channels;

FIG. 2 is magnified illustration of FIG. 1A and provides a view of the bus bars and interlocking coolant channels;

FIG. 3 is a perspective view of an embodiment of a subsystem and provides a view of the endplates connected to a rail having securing rings;

FIG. 4A is a three dimensional view of a battery module for use in a modular battery system showing band members securing the endplates;

FIG. 4B is an exploded view of an embodiment of the monoblock battery case of FIG. 4A showing the container, the cover and side wall cover plates;

FIG. 4C is a three-dimensional view of the monoblock container from FIG. 4A showing the partitions;

FIG. 4D is side view of the monoblock container shown in FIG. 4C, showing a side wall of the container;

FIG. 4E is a side view of the monoblock container shown in FIG. 4C showing a side wall opposite to that shown in FIG. 4D;

FIG. 4F is a horizontal cross-sectional view of the monoblock container of FIG. 4C showing the flow of coolant through the container in a series flow configuration;

FIG. 5A a top view illustration of an embodiment of modules aligned in series between a pair of rails which illustrates a coolant jumper to connect the coolant channels of the arrays;

FIG. 5B is a magnified illustration of FIG. 5A.

FIG. 5C is a top view of a modular battery system having two subsystems showing a preferred path of coolant flow through the modular battery system;

FIG. 6 is an exploded view of FIG. 1A that illustrates the connection points of a side rail to the endplates;

FIG. 7A is a three dimension side view of a preferred endplate of an embodiment of the present invention;

FIG. 7B is a three dimensional front view of a preferred endplate of an embodiment of the present invention;

FIG. 7C is an illustration of an embodiment of an endplate which may be used with monoblock modules of the present invention taken along line C-C of FIG. 7B to show a preferred embodiment of the ribs;

FIG. 7D is a three dimensional front view of an alternative embodiment of an endplate that may be used with the present invention;

FIG. 8A is a perspective view of an Integrated Control Unit (ICU) of an embodiment of the present invention;

FIG. 8B is a perspective view of an embodiment of a shunt and fuse that may be used with an embodiment of the present invention;

FIG. 9 is a perspective view of a preferred embodiment of the present invention wherein two 24 module battery systems are strung together;

FIG. 10A is a perspective view of an embodiment of a modular battery system wherein two monoblock modules are connected in series while disposed in a system housing;

FIG. 10B is an magnified side view of FIG. 10A, wherein two monoblock modules are secured with a hold down bar and module support beam;

FIG. 11 is a top view of an application of the modular battery system illustrated in FIG. 9, wherein the system is incorporated into a transportation application, specifically a bus;

FIG. 12A is an exploded perspective view of an embodiment of flow channels that may comprise the cooling manifold of the present invention;

FIG. 12B is a side view of an embodiment of a male tube section of a flow channel of the present invention; and

FIG. 12C is a side view of an embodiment of a female tube section of a flow channel of the present invention.

### DETAILED DESCRIPTION OF EMBODIMENTS OF THE INVENTION

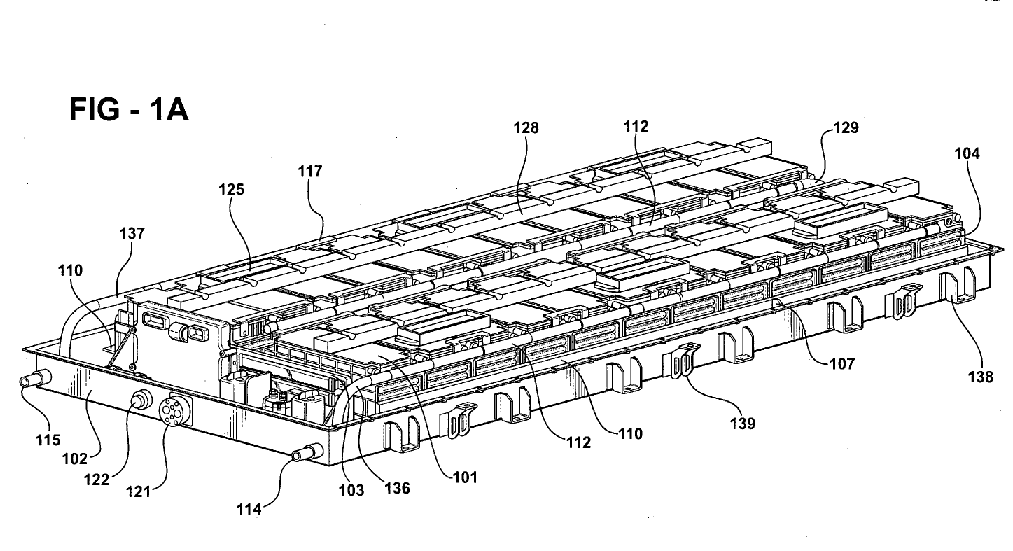

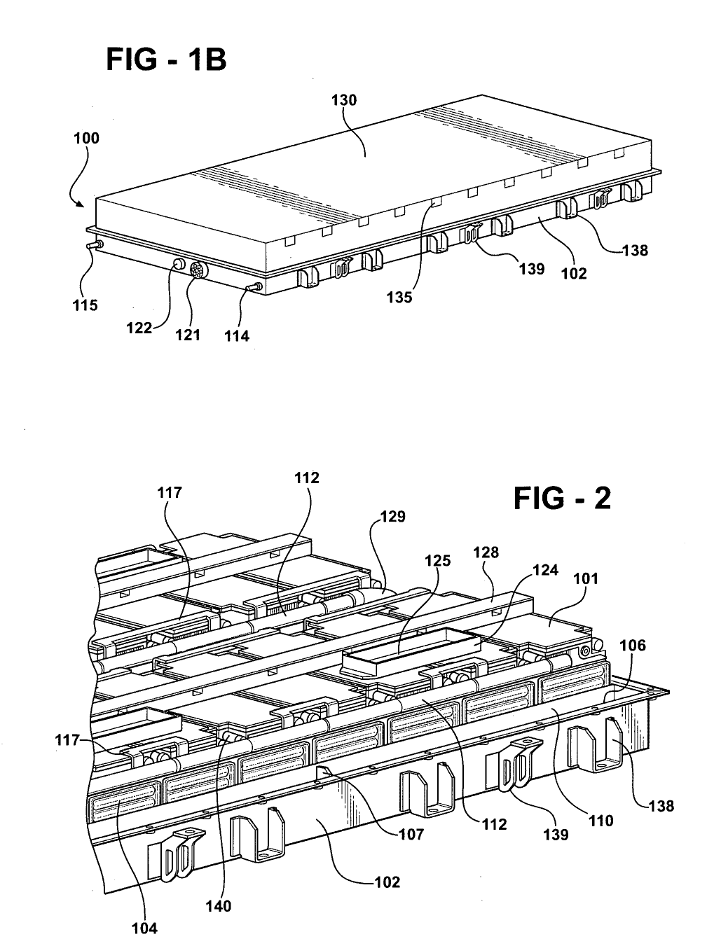

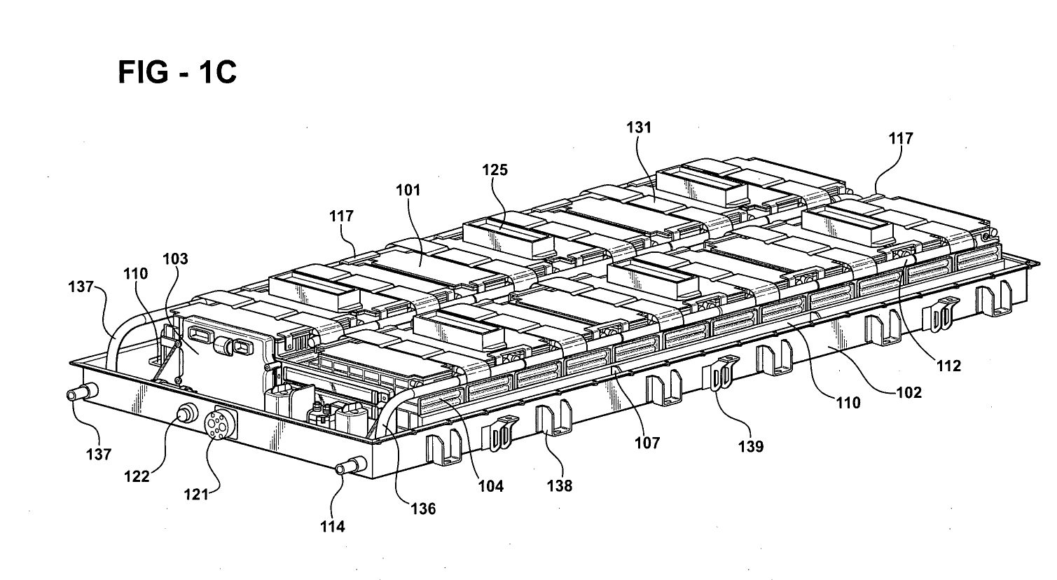

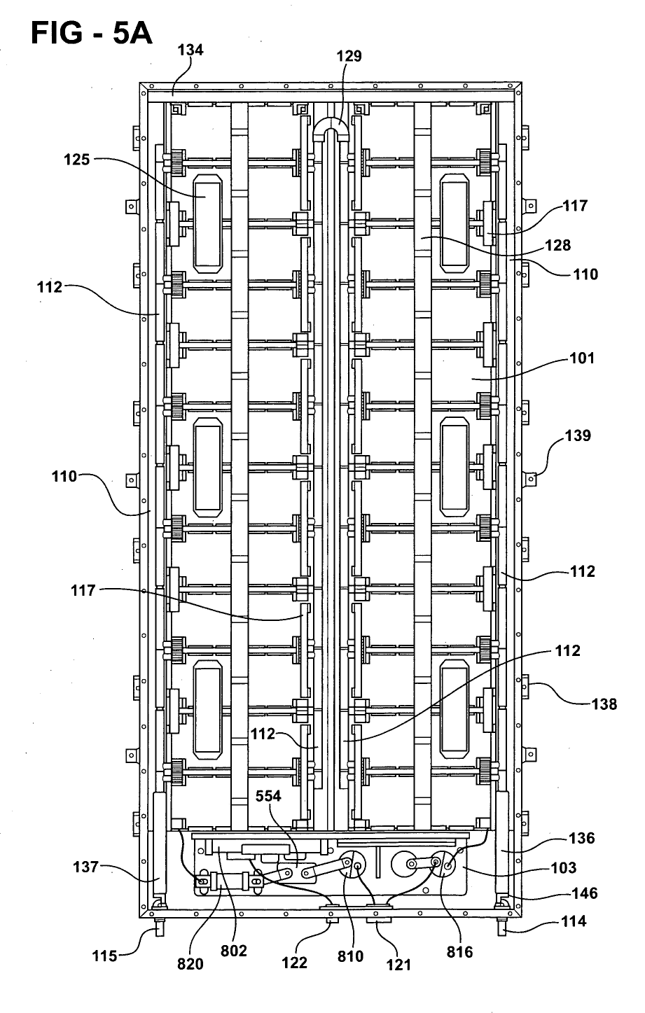

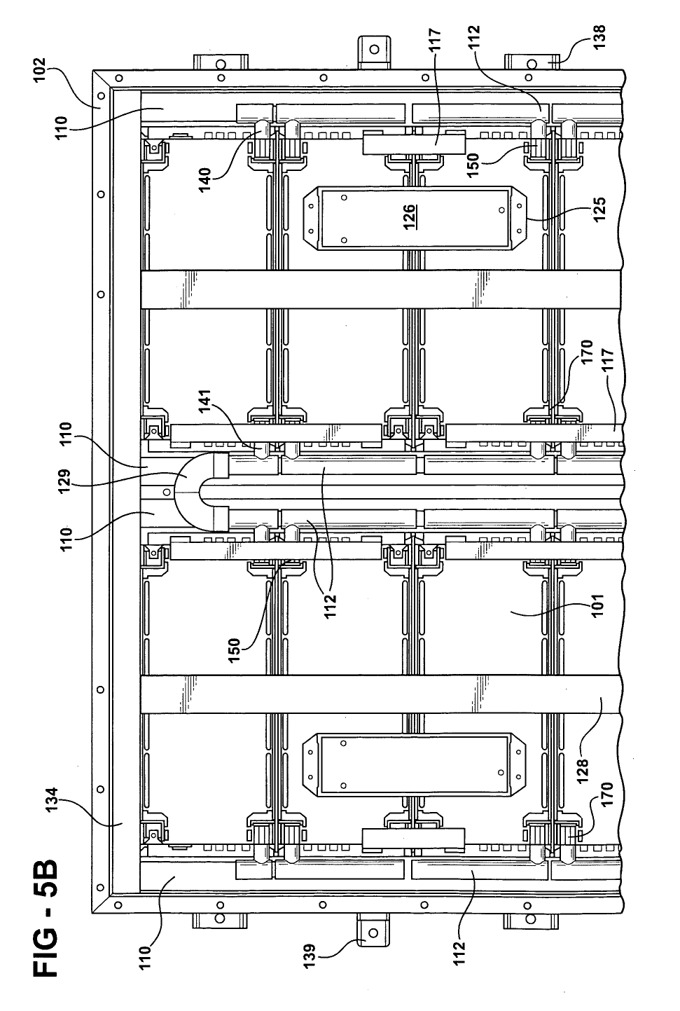

Disclosed herein is a modular battery system having a plurality of batteries, preferably monoblock batteries, interconnected electrically by bus bars and mechanically by rails and a cooling manifold. Referring to FIG. 1A, illustrated is an embodiment of a modular battery system, generally referred to as 100, wherein monoblock modules 101 are connected in series with bus bars 117. FIG. 1A illustrates a modular battery system comprised of twenty-four battery modules 101 electrically wired in series. The twenty-four battery modules 101 are arranged in a 12×2 array. The modular battery system may be set and secured in a system housing 102 with an integrated control unit (ICU) 103. The ICU 103 secures various components that may be utilized with a preferred embodiment of the system, as discussed below. Each module 101 is preferably secured between a pair of parallel rails. In this illustration, only the outside rail 110 is shown, however; for a view of both rails, refer to FIG. 5B. The module 101 is secured between the rails by bolts 106 threaded through the endplate 104 and the rail 110. Although the each endplate is preferably bolted to a rail, other securing methods, such as welding or adhesive, may be used. The system may include a remote sensing module (RSM) 126 and a RSM potting box 125 secured adjacent to a hold down bar 128. The RSM 126 and potting box 125 are discussed in more detail below. FIG. 1C illustrates an embodiment wherein channel clamps 131 are incorporated to secure the flow channels 112.

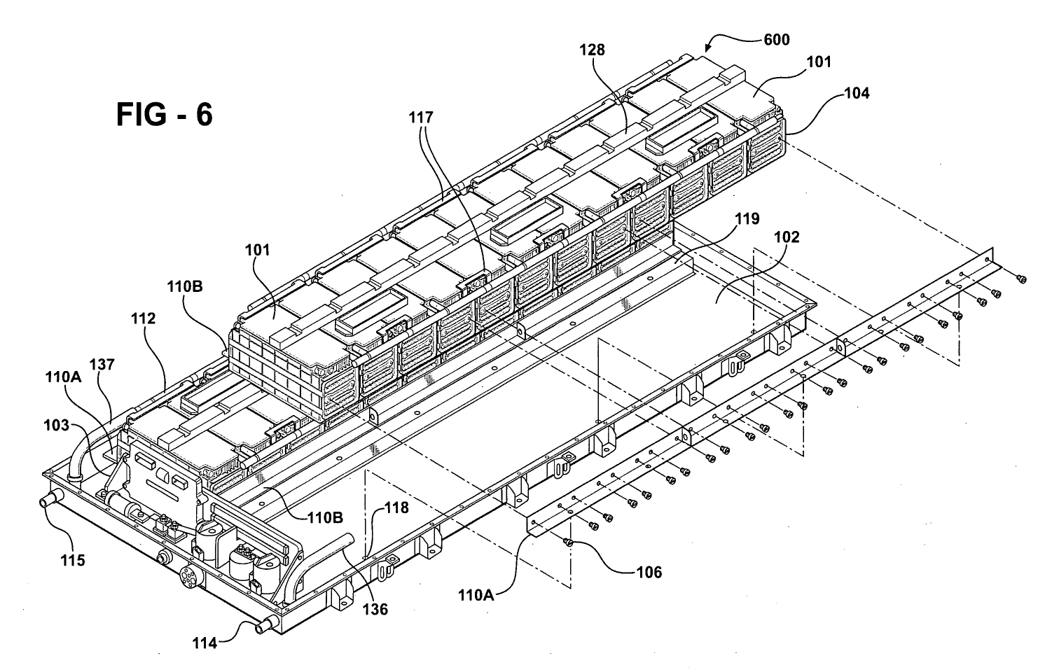

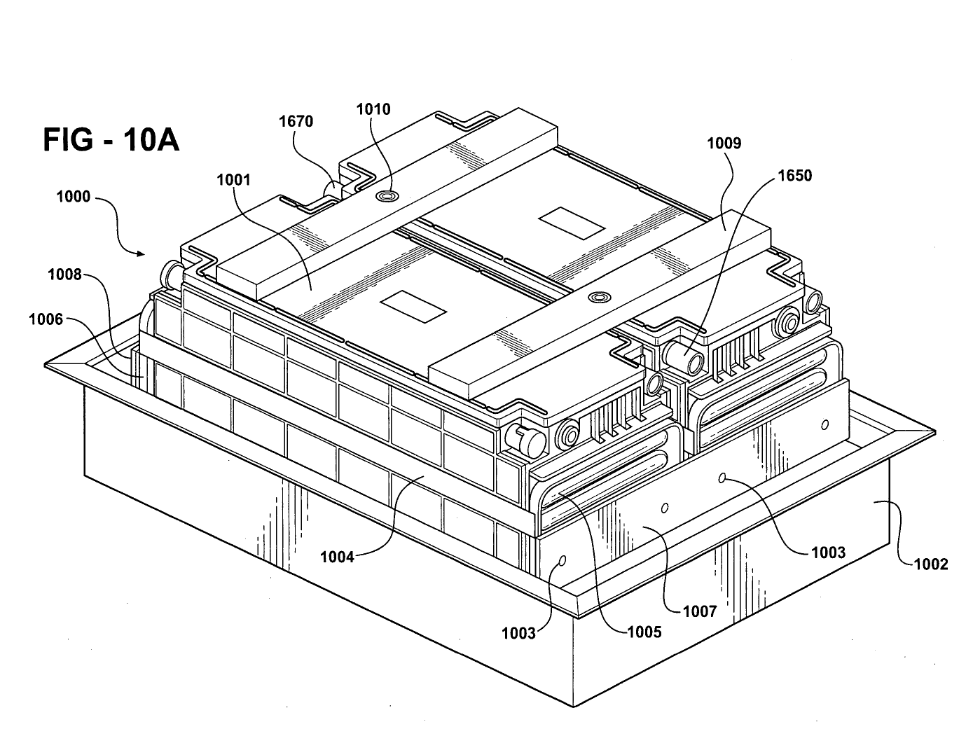

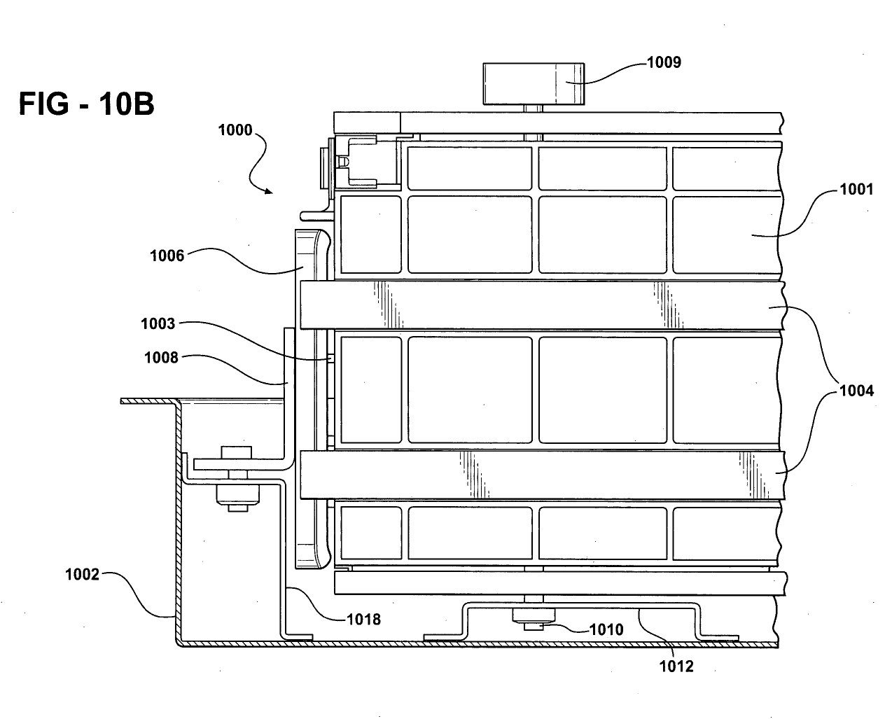

Referring to FIGS. 1A, 2, 3 and 6, the rail 110 may be equipped with at least one, preferably several securing rings 107. The securing rings 107 are used to transport or maneuver the module system arrays, independently or simultaneously, into and out the system housing 102. Preferably the outside rails have an L shape with one side of the L bolted to an endplate and the other side of the L welded to the side wall of the system housing and bolted to the base of the system housing. A bottom flange 118 (for a better view of the flange see reference number 1018 of FIG. 10B) may be used to secure the rail 110 to the base of the system housing 102. A bolt may be threaded through a weld stud 149 of the rail 110 and the flange 118. Securing the various components of the system enables the modular battery system of the present invention to withstand shock as it may be used in mobile applications. A support beam 119 may be secured to the base of the system housing 102 and as illustrated in FIG. 6, the rail 110 may be bolted or otherwise secured to a support beam 119.

The hold down bar 128 may be constructed of any material that may provide the needed stability for the system. Preferably, the hold bar 128 is constructed of a light weight material, such as any known polymer of sufficient thickness, although metal, such as aluminum or stainless steel, may be used. The preferred polymer is acrylonitrile butadiene styrene (ABS). The rails 110 may be constructed of any material that may provide the needed stability for securing the modules 101. Preferably, the rails 110 are constructed of a metal, such as aluminum or stainless steel, although the preferred metal is mild carbon steel. The preferred construction material for the system housing 102 and system cover 130 is

FIG. 6 illustrates an exploded view of a preferred manner in which a rail is secured to a subsystem, referred to generally as 600. Bolts 106 are threaded through the rail 110 and endplate 104 and the rail 110 is bolted to a flange 118. The flange 118 is secured, preferably welded, to the base of the system housing 102. Further, the rail 110 is preferably welded to the side of the system housing 102. In the embodiment illustrated, a flange (not shown) is secured on the sides of the system housing 102 and support beams 119 are secured in the center portion of the system housing 102. A separate flange (not shown) supports each of the side rails 110A and a separate support beam 119 supports each of the center rails 110B.

Preferably, the modular battery system of the present invention has a cooling manifold comprising a series of flow channels 112, as illustrated in FIGS. 1A and 5A. The flow channels 112 allow coolant to flow from a coolant inlet 114 through each module 101 and to a coolant outlet 115. An inlet interconnect 136 may be used to provide flow communication between the coolant inlet 114 and the coolant manifold and an outlet interconnect 137 may be used to provide flow communication between the coolant manifold and the coolant outlet 115. Further, a bulkhead 146 may be used to provide flow communication between an interconnect 136 or 137 and its respective inlet/outlet.

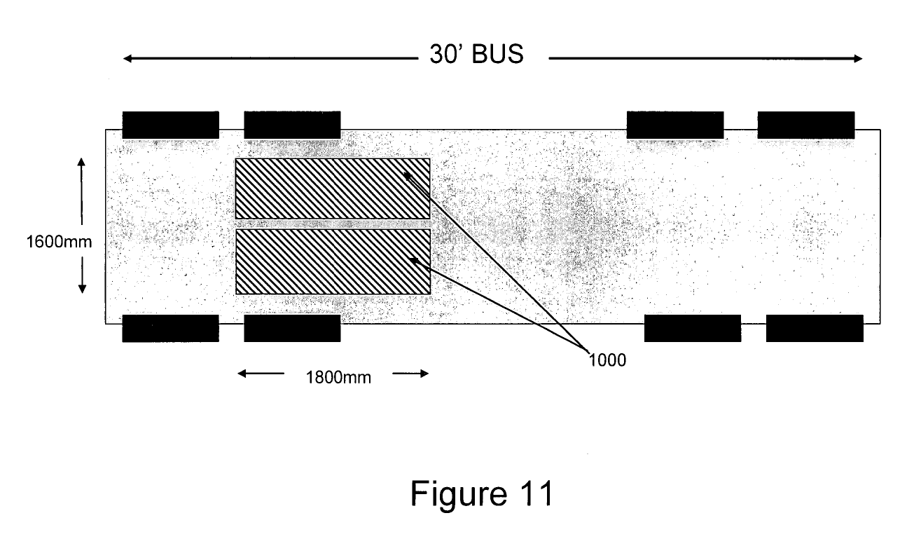

Referring to FIG. 1B, a system cover 130 is preferably secured to the system housing 102 via bolts or other securing mechanism. The system cover 130 provides protection from various elements, such as water and dust that may arise depending on the application. Further, the system cover 130 preferably creates a seal with the system housing 102, wherein the seal prevents the transfer of gases or moisture. Mounting feet 138 may provide a means to secure to system housing 102 to an object, such as a bus as illustrated in FIG. 11. A lifting bracket 139 may be secured to the system housing 102, preferably the peripheral edge, to assist in positioning and mounting the modular battery system 100 of the present invention. The power produced by the modules 110 may be accessed through a high voltage (HV) connector 121 or a low voltage (LV) connector 122. Preferably, the HV connector 121 has two size 0 cavities capable of 250 Amps, six size 16 cavities capable of 35 Amps and a twist lock or other securing mechanism. Preferably, the LV connector 122 has ten pin cavity housing capable of 5 Amps or 10 Amps. The HV connector 121 and LV 122 connector are preferred elements of the ICU 103, which is illustrated in FIG. 1A and discussed below.

Preferably, the system includes a mechanism for releasing gases, such as hydrogen gas, from the system while preventing the exit or entry of moisture. To help prevent moisture from exiting or entering the system housing 102 and the system contained therein, a gas-permeable, hydrophobic membrane may be incorporated into openings 135 in the system cover 130, as illustrated in FIG. 1B. The membrane coverings will prevent the escape or entry of moisture, such as water or electrolyte, from or to the system housing 102; however, since the membranes are preferably gas-permeable, they will permit the gases, such as hydrogen, produced by the system to be emitted from the housing 102.

The gas-permeable, hydrophobic membrane may be formed of a material that has a gas diffusion surface area sufficient to compensate for the overcharge gas evolution rate. The may be from about 5 cm² to about 50 cm² per 12 Ah cell. Generally, the hydrophobic material is any material which allows passage of gases, but not moisture. Examples of materials are materials comprising polyethylene with calcium carbonate filler. Other examples include many types of diaper material. An example of a material which may be used is the breathable type XBF-100W EXXAIRE film that is supplied by Tridegar products. This film is a polyethylene film that has been mixed with fine calcium carbonate particles and then further stretched to make it porous. In one embodiment, the layer is chosen to have a thickness of about 0.25 gauge (0.25 g per square meters), which corresponds to about 0.001 inch. The Gurley porosity of the material is chosen to be about 360 (360 seconds for 100 cc of gas to pass per square inch with a gas pressure of 4.9 inches of water). The hydrophobic nature of this film is demonstrated by a very high contact angle in 30% KOH electrolyte of about 120° C.

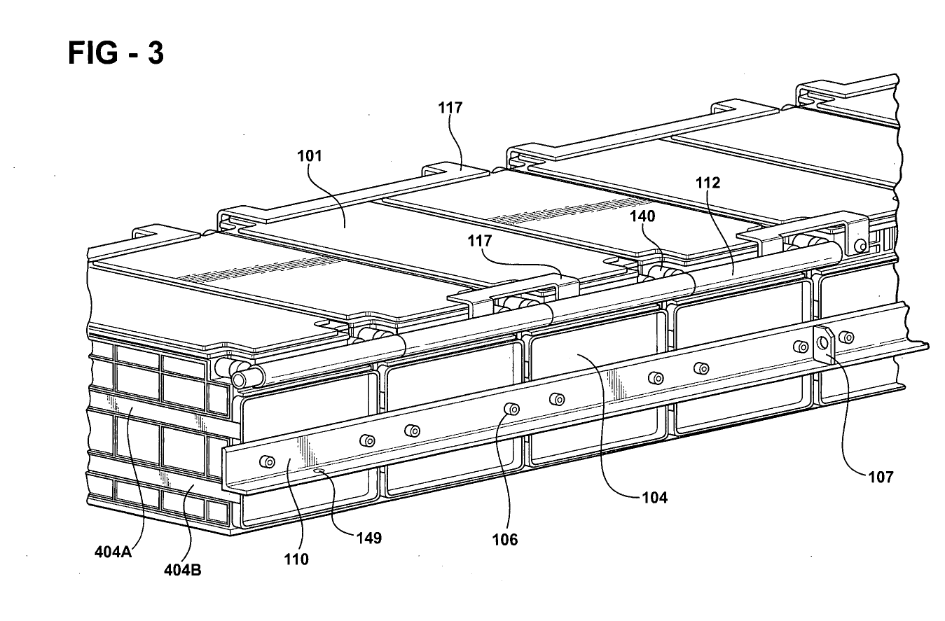

For ease of assembly and maintenance, an interlocking series of flow channels 112 is preferred, as illustrated in FIGS. 3, 5A and 5B. The battery modules 101 are set side by side and the interlocking flow channels 112 direct the flow of coolant to the module coolant inlet 150 attached to the flow channel outlet 140, through the battery module 101 and out the module coolant outlet 170 attached to the flow channel inlet 141, as illustrated in FIG. 5B. For design convenience, the cooling manifold may further include a coolant jumper 129 to connect the flow channels 112 of a first series of battery modules to the flow channels 112 of a second series of battery modules. A rear support 134 may also be incorporated. The flow channels 112 may be constructed of any material that may inhibit the leakage of coolant from the flow channels 112. Preferably, the flow channels 112 are constructed of a light weight material, such as any known polymer. The applicable polymers may include polystyrene, polypropylene and polysulfone.

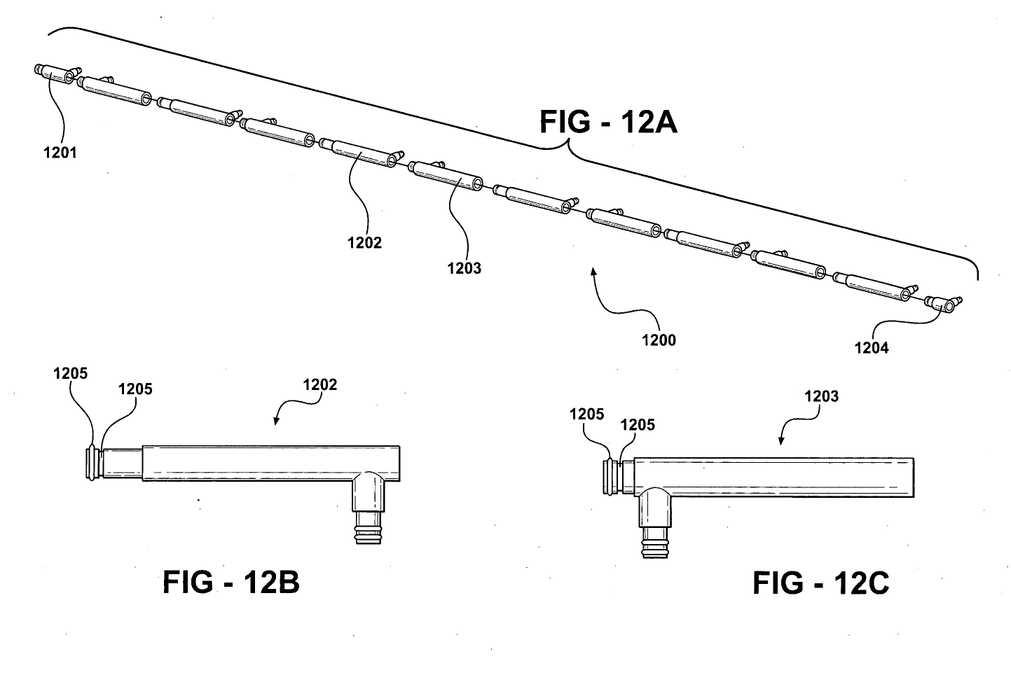

Referring to FIGS. 12A through 12C, an exploded view of the interlocking flow channels is illustrated, generally referred to as 1200. The interlocking sections are designed to allow a male tube 1202 to be inserted into a corresponding female tube 1203 of an adjoining section. A plugged end 1204 may be used to direct coolant through the last battery module of a series and a barbed end 1201 may be used to connect the channels 1200 to the outlet interconnect 137, from the inlet interconnect 136, or to each other via the coolant jumper 129, as illustrated in FIGS. 1A and 5A. O-rings 1205 may be set in each interlocking section at the point of connection to inhibit coolant leaks. Each flow channel section may be further secured with a clamp. In a preferred embodiment, each male or female manifold section is secured to a battery module coolant inlet or a battery module coolant outlet, depending of the position

The interlocking flow channels 112 allow the cooling manifold to be integrated after the modular battery system has been set into the system housing 102. However, the cooling manifold may be integrated prior to the modular battery system being set into the system housing 102.

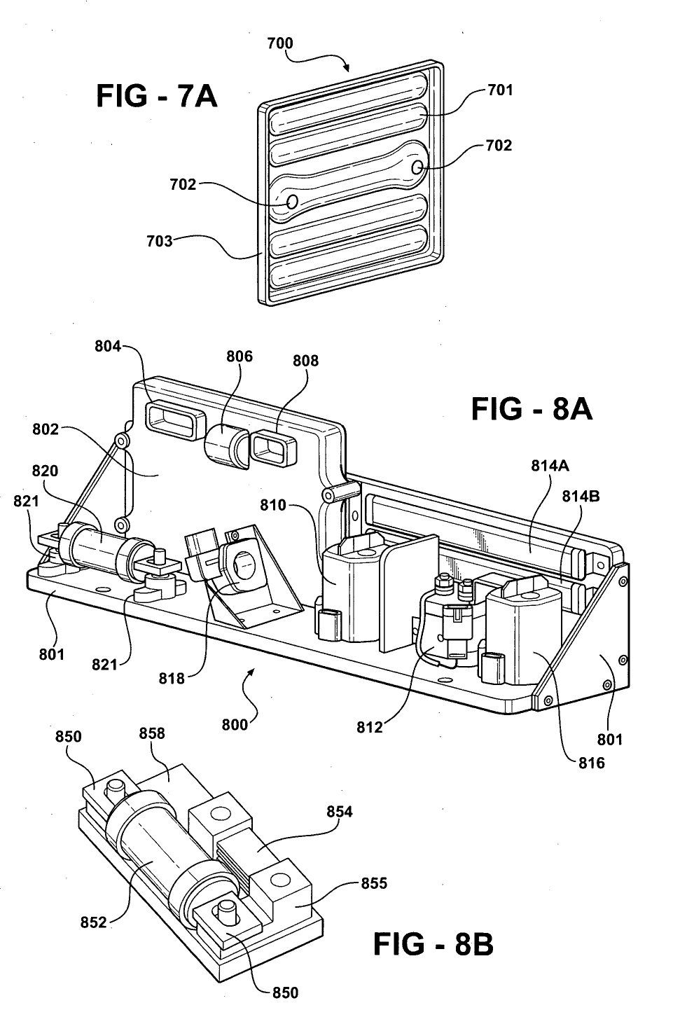

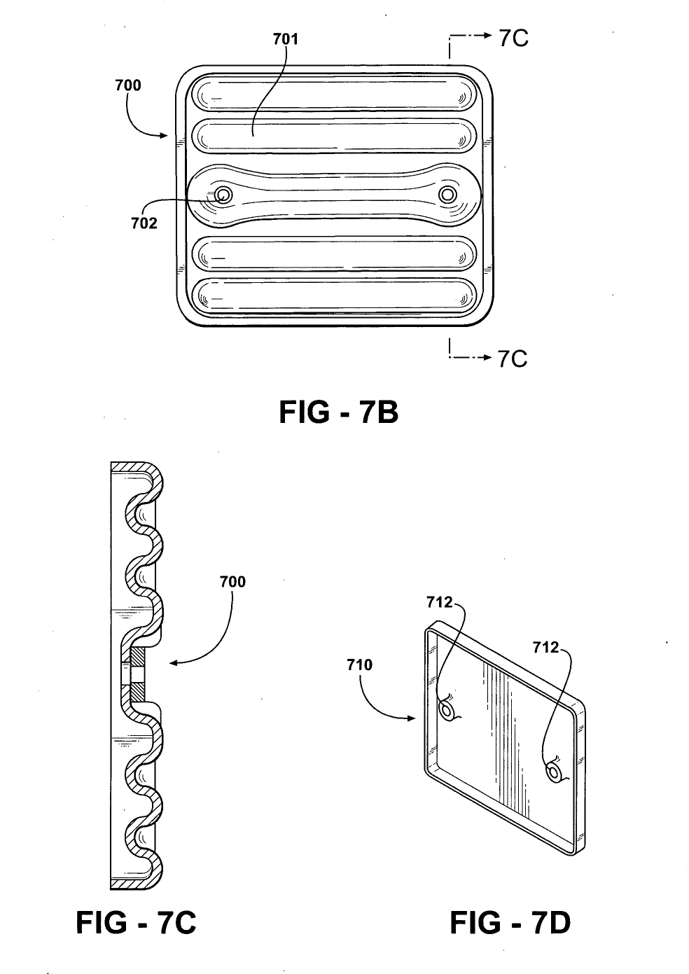

Referring to FIGS. 7A through 7C, the preferred endplate, referred to generally as 700, has a plurality of ribs 701 and weld studs 702. The ribs 701 of the endplate 700 provide structural support and mechanical stability for the module. Further, each endplate 700 preferably accommodates at least one weld stud 702 and the weld stud 702 provides an integration feature for building up a multiple module cassette. The weld studs 702 are used to secure the module 101 between a rail 110, as illustrated in FIGS. 1A and 3. The endplates 700 may be made of steel or stainless steel. However, the endplates 700 may be made of a material which is light and has such a sufficient strength in a given size that deformation is not caused by the increase of the internal pressure, in particular, a material including aluminum having excellent heat conductivity as a main component. FIG. 7D illustrates an alternative embodiment of an endplate, generally referred to as 710 that may be incorporated with the present invention. Similar to the above embodiment, each endplate 710 preferably accommodates at least one weld stud 712.

Referring to FIG. 5A, bus bars 117 preferably connect the modules 101 in series; however the modules 101 may be connected in parallel. The bus bars 117 may be in electrical communication with a main positive contactor 810 and a main negative contactor 816, wherein a module positive terminal is in electrical communication with the main positive contactor 810 and a module negative terminal is in electrical communication with the main negative contactor 816. FIG. 5A illustrates an embodiment wherein a module positive terminal electrically connects to the main positive contactor 810 via a fuse 820 and a shunt 554. The contactors 810 and 816 are preferably located on the ICU 103, as described below. The bus bars 117 are preferably constructed of an electrically conductive material, most preferably the bus bars are copper or a copper alloy which is preferably coated with nickel for corrosion resistance.

The battery system preferably includes all of the components required to cool the system. For example, the battery system may include a radiator, fan, pump, overflow bottle, coolant connections, manifolds, control of the system, and monitoring of the system. Further, power to control the fan and pump may be provided externally.

Referring to FIG. 8A, an integrated control unit (ICU), generally referred to as 800, may be incorporated into the modular battery system of the present invention. The ICU 800 preferably includes an ICU bracket 801 which provides structural support for various ICU electrical components, wherein the ICU bracket 801 is mounted and secured to the system housing. The ICU 800 may include a battery control module BCM 802, fuse 820, an in line current sensing device, such as a hall effect current transducer 818, main positive contactor 810, main negative contactor 816, pre-charge relay 812 and pre-charge resistors 814A and 814B.

The BCM 802 is a preferred element of a battery monitoring system (BMS). The BCM 802 is an embedded controller module providing communication interfaces, sense leads, and system control interfaces. Preferably, the BCM 802 fastens to the ICU 800 and slides into the ICU bracket 801, which secures the BCM 802 to the ICU bracket 801. The BCM 802 may include a low voltage harness connector 804, high voltage harness connector 808 and a precharge resistor, indicated by the boss 806. The BCM 802 provides functions such as internal RS485 communications, external CAN communications, measurement of battery pack voltage and current, control of the battery pack contactors, battery operating system and battery algorithms that monitor battery status as well as predict battery performance to allow effective control of the battery system by the system controllers. The BCM 802 is preferably in a centralized collection point for monitoring of the system and receives information that is collected by the RSMs set throughout the system. The BCM 802 is preferably constructed of a plastic that is able to withstand the pressures and temperatures of the system. The preferred plastic is a thermoplastic resin.

The fuse 820 provides protection against a low resistance short circuit across the battery system and the fuse holders 821 provide mounting studs for the fuse 820, as illustrated in FIG. 8A. Preferably, the fuse 820 is a FWJ 1000V high speed fuse. The hall effect current transducer 818 is an inline current sensing device providing voltage sense to electronics for calculation of battery system current. Preferably, the hall effect current transducer is in line between the fuse 820 and main positive contactor 810. Other measurement devices, such as a shunt, may be used in place of the hall effect current transducer. The modular battery system of the present invention may include an external +24 VDC (22 VDC−28 VDC) power supply/return to provide power to the system. The system may incorporate a DC/DC converter to convert 24 VDC input to 12 VDC for the electronics.

The main positive contactor 810 is a relay which connects the high voltage positive connection from the hall effect current transducer 818 to the HV connector, preferably through 1/0 high voltage cable, as illustrated in FIG. 8A. The precharge contactor 812 is a relay which is used to “precharge” the system by connecting the high voltage negative to the HV connector through the precharge resistors 814A and 814B, a bus bar, and wiring to control the amount of current switched while bringing the system voltage up to battery voltage. This protects the contactors 810 and 816 by limiting inrush current due to the capacitance of the high voltage bus. Preferably, the external system ensures that loads are removed from the system during a precharge sequence. The main negative contactor 816 is a relay which connects the high voltage negative connection from the battery main negative to the HV connector, preferably through 1/0 high voltage cable. The precharge resistors 814A and 814B are connected between the high voltage negative and precharge contactor 812 to control current during precharge of the system. Preferably, the resistors 814A and 814B are non-inductive ceramic resistors. The pre-charge resistors 814A and 814B are preferably connected in series, but may be connected in parallel.

The modular battery system preferably includes a design to allow precharge of the high voltage bus. This protects that system's contactors by limiting inrush current due to the capacitance of the high voltage bus. The external system must ensure that loads are removed from the system during the precharge sequence. The precharge circuit and SW control may be designed such that the precharge sequence completes within a given time when the “connect” command has been sent to the system. A protection strategy may be incorporated to ensure that the precharge circuitry does not become overheated due to repeated precharge attempts.

A shunt 854, as illustrated in FIG. 8B may be used in place of the hall effect current transducer to act as an inline current sensing device providing voltage sense to electronics for calculation of battery system current. FIG. 8B illustrates an embodiment of a shunt 854 and fuse 852 that may be used with the present invention. Preferably, the fuse holders 850 provide mounting studs for the fuse 852 and the shunt base 858 is designed with a recess, boss and threaded stud to accommodate the fuse 852. The shunt 854 may be an 800 A @ 15 mV shunt. The conductor 855 may be extended with a threaded stud to mount the fuse 852. FIG. 5A illustrates an embodiment, wherein a shunt 554 is incorporated as an inline current sensing device in line between a fuse 820 and a main positive contactor 810.

A remote sensing module (RSM) 126, also a preferred element of the BMS, is directly connected to at least one battery module 101. A preferred embodiment is an RSM 126 connected to four modules 101. The RSMs 126 collect performance and status information of each module 101, such as voltage and temperature. Each potting box 125 is preferably secured to a module 101. In a preferred embodiment illustrated in FIGS. 1A, 1C and 5A, six addressed RSMs 126 are incorporated into a system having 24 battery modules 101, wherein each RSM 126 relays the measurement of the four battery voltages and one battery temperature. The addresses of the RSMs 126 allow the BCM 802 to retrieve the data from all of the RSMs 126 independently. Each RSM 126 relays the collected information to the BCM 802. Preferably, the RSM 126 communicates as a slave with the BCM over an internal RS485 communications link. The BMS preferably monitors and tracks the state of charge (SOC) of the battery modules by using information collected by the RSMs 126. Further, algorithms may be utilized to predict the SOC of the battery modules and the modular battery system.

For safe and effective operation of the modular battery system, the design preferably includes contactors within each sub-pack as well as an enclosed high voltage interface box where all of the sub-pack connections will be brought together and interfaced to the external system. In addition to the contactor isolation in each sub-pack, a pilot loop back connection in the high voltage connectors will remove 12 V from the contactor coils in that pack if the high voltage connector is removed. This ensures that there will not be high voltage on the pack's connector if it has been removed

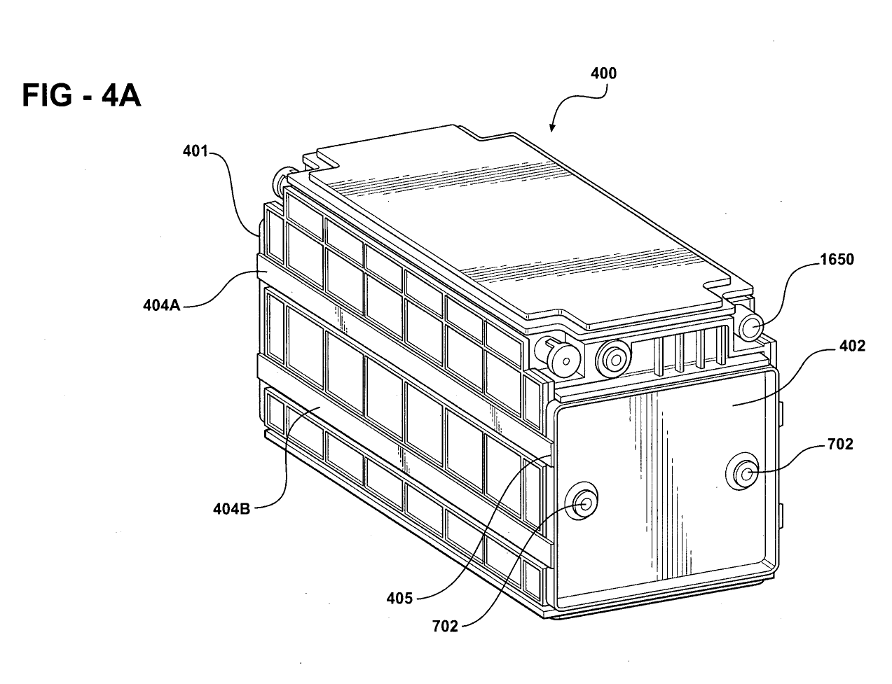

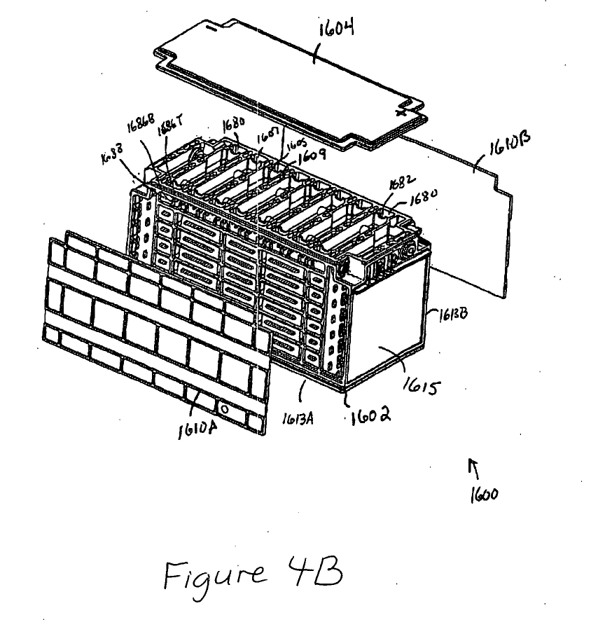

Referring to FIG. 4A, a preferred battery module for a modular battery system disclosed herein. The module 400 is enclosed on all sides with individual cell compartments contained therein. The module 400 may be set between a first endplate 401 and a second endplate 402, at least one band member coupling the first and second endplates 401 and 402 to each other and binding said battery module 400 between the endplates 401 and 402. Two band members 404A and 404B are illustrated in FIG. 4A. On the upper and lower portions of the outer surfaces of the narrower side walls of the endplates 401 and 402 recesses may be provided for positioning and fitting band members.

In a preferred embodiment of a modular battery system of the present invention, a multi-cell monoblock battery case shown in FIG. 4B is incorporated. The case 1600 includes the battery container 1602, the lid for the container 1604. In the embodiment shown, the case also includes wall covers 1610A, B that fit over the corresponding side walls of the case.

A three-dimensional view of the container 1602 is shown in FIG. 4C. Referring to FIG. 4C, the container 1602 includes two side walls 1613A, B and two end walls 1615. FIG. 4C shows a first side wall 1613A. The side wall 1613B is opposite to 1613A and is hidden from view. Likewise, the first of the two end walls 1615 is shown in FIG. 4C while the second end wall is opposite the first end wall and is hidden from view. The container 1602 further includes one or more cell partitions 1607, 1609 which divide the interior of the case into a plurality of cell compartments 1605. The battery case may hold one or more electrochemical cells and preferably holds at least two electrochemical cells. Preferably, each of the electrochemical cells is placed in its own corresponding cell compartment. The electrochemical cells may be coupled together is series and/or parallel configuration.

Each of the cell partitions may be either a divider partition 1607 or a coolant partition 1609. The divider partitions 1607 do not include coolant channels while the coolant partitions 1609 include coolant channels. Preferably, the container 1602 includes at least one coolant partition. Preferably, the coolant channels are formed integral with the coolant partitions. More preferably, the coolant channels are preferably formed in the interior of the coolant partitions. In addition, the coolant partition may be formed as a one-piece construction.

In the embodiment of the container 1602 shown in FIG. 4C, the inlets and outlets of the coolant channels are formed in the side walls of the container. Each opening 1620 may be either an inlet or an outlet of a coolant channel depending upon the direction of the coolant flow within the coolant channel. The coolant channels guide the coolant from one side wall to the opposite side wall. This is another example of a “cross-flow design”. In the container shown in FIG. 4C, the coolant channels are substantially horizontally disposed and the direction of the coolant flow is substantially parallel to the external faces of the coolant partition.

Preferably, the coolant channels within one of the coolant partitions are in communication with the coolant channels in the other coolant partitions. This creates a completely integrated cooling system that permits the coolant to flow through all of the coolant partitions. The coolant channels of different coolant partitions can be fluidly connected together in many different ways. In the embodiment of the battery case 1600 shown in FIG. 4C, this is done using wall covers 1610A, B. Preferably, the wall covers 1610A, B are in the form of rigid plates.

FIG. 4D is a side view of the container 1602 showing the side wall 1613A (which is also referred to as the coolant port side of the container). FIG. 4E is a side view of the opposite side of the container showing the side wall 1613B (also referred to as the gas port side of the container) which is opposite to side wall 1613A. Referring to the side views of FIGS. 4D and 4E it is seen that the outer surfaces of the side walls 1613A, B of the container 1602 includes ribs 1643. The ribs 1643 define baffles for fluid flow purpose. Specifically, the ribs 1643 define fluid pathways on the outer surface of the side walls 1613A, B. When a wall cover 1610A, B (shown in FIG. 16A) is affixed to its corresponding side wall 1613A, B the fluid pathways in combination with its corresponding wall cover 1610A, B define wall connector channels 1645 (also referred to herein as wall flow channels). These wall connector channels 1645 interconnect the openings 1620 of the coolant channels of different coolant partitions. Hence, the coolant channels of each of the coolant partitions are interconnected with the coolant channels of other coolant partitions. This creates an interconnected network of coolant channels that can circulate the coolant throughout the battery case. It is noted that the combination of a side wall 1613A, B and its attached corresponding wall cover 1610A, B collectively forms a side wall that is dual-layered. The wall coolant channels are thus within these dual-layered side walls.

There are many other ways to interconnect the coolant channels. For example, wall connector channels may be formed as separate pieces (such as tubes) that are integrally coupled to the openings 1620 in the side walls 1613A, B.

The coolant can be made to circulate through the container 1602 in different ways. In the embodiment of container shown in FIG. 4C, the coolant is directed to flow in a serpentine path, back and forth between the opposite side walls. FIG. 4F is a horizontal cross-sectional view of the container 1602 which more clearly shows the path of the coolant through the coolant channels. FIG. 4F shows the divider partitions 1607 and the coolant partitions 1609. FIG. 4D also shows the wall connector channels 1645 which are defined by the first side wall 1613A and its corresponding wall cover 1610A, and the wall connector channels 1645 defined by the second side wall 1613B and its corresponding side wall cover 1610B. The arrows shown within the wall connector channels 1645 and the coolant channels show the direction of coolant flow.

Referring to FIG. 4F, the coolant enters the container 1602 through the container inlet 1650 and is directed to the opening 1620A (a channel inlet) in the first side wall 1613A. The coolant is directed by the coolant channel in the coolant partition 1609 to the opening 1620B (a channel outlet) in the second side wall 1613B (which is opposite the first side wall 1613A). The wall connector channel 1645 in the second side wall 1613B then directs the coolant to the opening 1620C (a channel inlet) where it is carried by the coolant partition 1609 back to the first side wall 1613A and exits the opening 1620D (a channel outlet). This process repeats for the other cooling channel openings 1620E through 1620L where the coolant is then directed to the container outlet 1670. Hence, the coolant is carried back and forth between the first and second side walls by the coolant channels in the coolant partitions. As discussed above, this type of flow is referred to as a “serial” connection, since the coolant is routed from one partition to another.

As gases (such as oxygen and hydrogen) are given off by the electrochemical cells of the battery there is a need to vent the gases from the battery. In the process of venting the gases, some of the electrolyte from each of the cells may be carried along with the gases and escape from its corresponding cell compartment. While it is acceptable for the gases of one electrochemical cell to intermix with the gases of another electrochemical cell, it is not acceptable for the electrolyte of one cell to enter another electrochemical cell. Hence, in the design of a gas venting system for a battery, care must be taken to prevent the electrolyte from one cell from entering any of the other electrochemical cells of the battery. For purposes of discussion, the electrolyte which escapes from its cell compartment is referred to as “escaped electrolyte”.

Referring again to FIGS. 4D and 4E it is seen that the sidewalls 1613A, B further include ribs 1686B and 1686T. The ribs 1686B, T define baffles for fluid flow purpose. Specifically, the regions between the ribs 1686B, T define pathways on the surface of the side walls 1613A, B.

When a wall cover 1610A,B (as shown in FIG. 4B) is affixed to its corresponding side wall 1613A,B, the sidewall 1613A,B, the corresponding wall cover 1610A,B and the ribs 1686B,T define the gas channels 1688. Each of the gas channels 1688 is in communication with each of the cell compartments 1605 and each of the electrochemical cells by way of holes 1684 (seen in FIGS. 4D and 4E). It is noted that in the embodiment of the battery case shown in FIGS. 4D and 4E, the holes 1684 are preferably not covered by any type of membrane material. Both cell gas as well as liquid electrolyte can make its way from each of the cell compartments to each of the gas channels. Hence, each of the gas channels 1688 is preferably in gaseous communication as well as in liquid communication with each of the cell compartments (hence, each of the cell compartments may be described in being in fluid communication with each of the gas channels). As noted above, the combination of a side wall 1610A, B and its corresponding wall cover 1610A, B collectively form a dual-layered side wall. Hence, the gas channels 1688 are within these dual-layered side walls.

As gas is given off by each of the electrochemical cells of the battery, the cell gas along with escaped electrolyte enters (by way of grooves 1682) the tubs 1680 adjacent to the corresponding cell compartment 1605 (shown in FIG. 4C). A portion of the escaped electrolyte is trapped in the tubs 1680 thereby preventing this portion of the escaped electrolyte from reaching any of the other electrochemical cells. The cell gas and a remaining portion of the escaped electrolyte exit the tubs 1680 through openings 1684 (shown in FIGS. 4D and 4E) and enter the gas channels 1688. (Hence, the gas channels 1688 transports cell gas as well as liquid electrolyte carried along with the cell gas). The cell gas that enters the gas channel 1688 on the side wall 1613B (shown in FIG. 4E) follows a path through the gas channel and, when the gas pressure gets sufficiently high, exits the gas channel through the gas vents 1670.

The placement of the ribs 1686B, T forms a gas channel 1688 preferably having a tortuous flow path. As the cell gas and the escaped liquid electrolyte travel through the gas channels 1688, they are forced by the gas channels 1688 to follow the corresponding tortuous flow path of the channels. Because of the tortuous flow path followed by the gas and the escaped electrolyte, the escaped electrolyte is trapped in the bottom of the wells 1690 defined by the bottom ribs 1686B. Because the escaped electrolyte is trapped by the wells 1690, substantially none of the electrolyte from one cell compartment 1605 enters another cell compartment 1605. Hence, substantially none of the electrolyte from one electrochemical cell contacts any other electrochemical cell.

As noted, the cell gas exits the channel shown in FIG. 4E via the gas vents 1694 positioned on opposite ends of the gas channel. Hence, in the embodiment of the battery case shown in FIGS. 4B-E, gas vents are coupled to only one of the gas channels. However, it is of course possible to place one or more gas vents on the gas channel on each of the side walls. Likewise, the battery may be made to have only a single gas channel on only one of the side walls.

The gas channels may be formed to have any tortuous flow path. For example, the flow path may be serpentine, circuitous, winding, zigzag, etc. In the embodiment shown in FIGS. 4D and 4E, the gas channels 1688 have a serpentine flow path created by an alternating placement of essentially vertically disposed ribs 1686B and essentially vertically disposed ribs 1686T. However, tortuous flow paths may be formed in many different ways. For example, it is possible that the top ribs 1686T be removed so as to leave only the bottom ribs 1686B to form the gas channel. In this case, the remaining ribs 1686B would still create a tortuous flow path for the cell gas and the escaped electrolyte. Also, it is possible that the ribs be placed at angles. Also, it is possible that the ribs 1686B, T be replaced by nubs, prongs, dimples or other forms of protrusions that cause the cell gas and escaped electrolyte to follow a flow path that is tortuous.

The gas channels 1688 shown in FIGS. 4D and 4E are each in fluid communication with each of the compartments 1605 by way of the holes 1684. Hence, the gases from all of the electrochemical cells placed in the battery case are allowed to intermix within each gas channel 1688 so that the battery case serves as a single or common pressure vessel for each of the electrochemical cells. However, it is also possible that the battery include multiple gas channels wherein each one of the gas channels is in fluid communication with less than all of the compartments. For example, each gas channel may be in communication with at least two of the compartments. It is also possible that each compartment have a unique corresponding gas channel and a unique corresponding gas vent so that the gases do not intermix.

As noted above, the gas channels 1688 are defined by the side walls 1613A, B, the corresponding wall covers 1610A, B, and the ribs 1686B, T. However, gas channels may be formed in other ways. For example, the gas channels may be formed as elongated tubes with interior ribs to form a tortuous flow path. The tubes may be made as separate pieces and then made integral with one or both of side walls of the case by being attached to the case. The tubes and the side walls of the case may be integrally formed as a single-piece by, for example, being molded as a single piece or by being fused together in a substantially permanent way. The gas channels may be within the interior of the side walls or on the exterior surface of the side walls. Hence, it is possible to eliminate the need for a separate wall cover.

Also, in the embodiment of the discussed above, the gas channels are integral with the side walls of the battery case. It is also possible that the gas channels be made integral with any part of the battery case. For example, a gas channel may be made integral with one or both of the end walls of the battery case. It is also possible that the gas channel be made integral with the top of a battery case. It is also possible that a gas channel be made integral with the lid of the battery case. The lid itself may be formed to have a top and overhanging sides. The gas channel may be made integral with either the top of the lid or one of the overhanging sides of the lid.

It is further noted that the gas channels of the present invention may be used with any multi-cell battery and with any battery chemistry. In the embodiments shown, the gas channels are used in a multi-cell battery that also includes coolant channels. However, this does not have to be the case. The gas channels may be used in battery module configurations that do not include coolant channels.

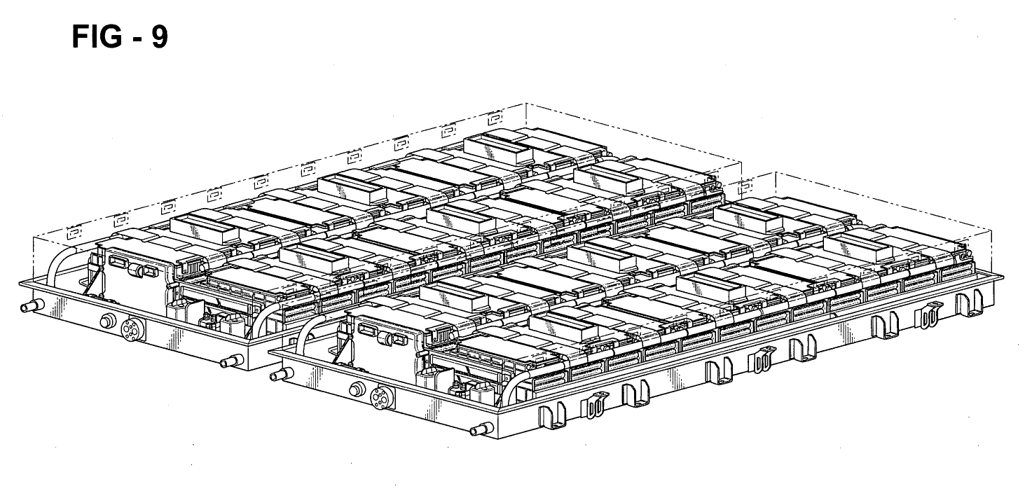

Referring to FIG. 9, a preferred embodiment is illustrated. The modular battery system is a component of a larger modular system which is a built by stringing two modular battery systems together to form a high voltage string. Each of the modular battery systems illustrated is comprised of twenty-four battery modules electrically wired in series. The twenty-four battery modules are arranged in a 12×2 array. FIG. 11 illustrates an application of the system illustrated in FIG. 9. A transportation application may comprise a bus, wherein the system housing is secured to the roof of the bus and provides power to the drive system to reduce internal combustion engine emissions and reduce fossil fuel consumption.

FIG. 10A illustrates an embodiment of a modular battery system, generally referred to as 1000, wherein two monoblock modules 1001 are connected in series while disposed in a system housing 1002. Each module 1001 is bound between a first 1005 and second endplate 1006 with two band members 1004 (the second band member is obstructed by the system housing). The endplates 1005 and 1006 may be secured between a pair of rails 1007 and 1008 using bolts 1003 or other securing mechanism. Referring to FIG. 10B, a support beam 1012 is secured to the base of the system housing 1002. A bolt 1010 may be threaded through a hold down bar 1009 between the modules 1001 and through a support beam 1012. A rail 1008 may be secured to the system housing 1002 using a bolt (not shown) threaded through the rail and a bottom flange 1018. Preferably, the bottom flange 1018 is welded or otherwise secured to the system housing 1002.

While the invention has been illustrated in detail in the drawings and the foregoing description, the same is to be considered as illustrative and not restrictive in character as the present invention and the concepts herein may be applied to any formable material. It will be apparent to those skilled in the art that variations and modifications of the present invention can be made without departing from the scope or spirit of the invention. For example, the flow of coolant may follow a different path depending on the particular battery modules incorporated, other electronics may be used to monitor the system, any multiple of subsystems may be disposed in the system housing depending of the size of the system housing and the intended application, any multiple of battery modules may be disposed in the system housing depending of the size of the system housing and the intended application. Thus, it is intended that the present invention cover all such modifications and variations of the invention that come within the scope of the appended claims and their equivalents.

We claim:

1. A modular battery system comprising:
a plurality of battery modules;
each of said battery modules having a first endplate and a second endplate, each of said battery modules set between said first and second endplates;
at least one band member coupling each of said first and second endplates to each other and binding said battery module between the endplates; and
a pair of rails, wherein said endplates are secured between said rails.

2. The modular battery system of claim 1, further comprising a system housing, wherein said rails are secured to said system housing.

3. The modular battery system of claim 1, further comprising a cooling manifold, said cooling manifold flowing coolant into said system, through each of said plurality of battery modules and out of said system.

4. The modular battery system of claim 3, said manifold comprising interlocking flow channels.

5. The modular battery system of claim 1, further comprising bus bars to connect the plurality of battery modules in series.

6. The modular battery system of claim 2, further comprising a hold down bar, said hold down bar securing the plurality of modules to said system housing.

7. The modular battery system of claim 2, further comprising an integrated control unit disposed in said system housing.

8. The modular battery system of claim 1, each of said endplates having at least one rib.

9. The modular battery system of claim 1, wherein said first and second endplates and said band members are made of a material selected from the group consisting of aluminum, an aluminum alloy, steel and stainless steel.

10. The modular battery system of claim 1, further comprising a battery monitoring system.

11. The modular battery system of claim 10, said battery monitoring system including at least one remote sensing module in electrical communication with at least one of said battery modules and a battery control module, wherein each remote sensing module transmits performance and status information of each battery module to said battery control module.

12. The modular battery system of claim 7, said integrated control unit including a battery control module, a fuse, a shunt, a main positive contactor, a main negative contactor, a pre-charge relay and at least one pre-charge resistor.

13. The modular battery system of claim 7, further comprising at least one remote sensing module in electrical communication with at least one of said battery modules, wherein said remote sensing module collects performance and status information of each battery module.

14. The modular battery system of claim 2, said system housing having a side wall and a base, wherein said rail is welded to said side wall and bolted to said base via a flange.

15. The modular battery system of claim 14, further comprising a system cover secured to said system housing.

16. The modular battery system of claim 14, said system cover having at least one gas-permeable, hydrophobic membrane, said membrane preventing the transfer of moisture through the system cover and allowing the transfer of gas through the system cover.

17. A modular battery system comprising:
a plurality of battery modules;
each of said battery modules having a first endplate and a second endplate, each of said battery modules set between said first and second endplates;
a plurality of band member coupling each of said first and second endplates to each other and binding said battery module between the endplates;
a pair of parallel rails, wherein said endplates are secured between said rails; and
a cooling manifold, said cooling manifold comprising flow channels directing coolant into and out of each of said battery module.

18. The modular battery system of claim 17, said flow channels comprising interlocking flow channels.

19. The modular battery system of claim 17, further comprising a system housing, said modular battery system disposed in said system housing.

20. The modular battery system of claim 19, said system housing having a coolant inlet and a coolant outlet, wherein said cooling manifold is in flow communication with said coolant inlet and said coolant outlet.

21. The modular battery system of claim 17, further comprising a battery monitoring system.

22. The modular battery system of claim 21, said battery monitoring system including at least one remote sensing module in electrical communication with at least one of said battery modules and a battery control module, wherein each remote sensing module transmits performance and status information of each battery module to said battery control module.

23. The modular battery system of claim 19, further comprising an integrated control unit disposed in said system housing.

24. The modular battery system of claim 23, said integrated control unit including a battery control module, a fuse, a shunt, a main positive contactor, a main negative contactor, a pre-charge relay and at least one pre-charge resistor.

25. The modular battery system of claim 23, further comprising at least one remote sensing module in electrical communication with at least one of said battery modules, wherein said remote sensing module collects performance and status information of each battery module.

26. A modular battery system having at least one subsystem comprising a plurality of battery modules connected in series, said subsystem comprising:
each of said battery modules having a first endplate and a second endplate, each of said battery modules set between said first and second endplates;
a plurality of band members coupling each of said first and second endplates to each other and binding said battery module between the endplates;
a pair of rails, wherein said endplates are secured between said rails; and
a cooling manifold, said cooling manifold comprising flow channels directing coolant into and out of each of said battery module.

27. The modular battery system of claim 26, said at least one subsystem comprising at least a first subsystem and a last subsystem.

28. The modular battery system of claim 27, each of said subsystems disposed in a system housing, said system housing having a coolant inlet and a coolant outlet.

29. The modular battery system of claim 28, the first subsystem cooling manifold and the last subsystem cooling manifolds connected by a coolant jumper.

30. The modular battery system of claim 29, said coolant inlet in flow communication with said first subsystem cooling manifold and said coolant outlet in flow communication with said last subsystem cooling manifold.

31. The modular battery system of claim 30, said system housing further comprising a low voltage connector and a high voltage connector.

32. The modular battery system of claim 31, said low voltage connector in electrical communication with

33. The modular battery system of claim 31, said high voltage connector in electrical communication with

34. The modular battery system of claim 26, further comprising a battery monitoring system.

35. The modular battery system of claim 34, said battery monitoring system including at least one remote sensing module in electrical communication with at least one of said battery modules and a battery control module, wherein each remote sensing module transmits performance and status information of each battery module to said battery control module.

36. The modular battery system of claim 26, further comprising an integrated control unit.

37. The modular battery system of claim 36, said integrated control unit including a battery control module, a fuse, a shunt, a main positive contactor, a main negative contactor, a pre-charge relay and at least one pre-charge resistor.

38. The modular battery system of claim 37, further comprising at least one remote sensing module in electrical communication with at least one of said battery modules, wherein said remote sensing module collects performance and status information of each battery module and relays said information to said battery control module.
